(19) United States
(12) Patent Application Publication
(10) Pub. No.: US 2009/0043688 A1
(43) Pub. Date: Feb. 12, 2009

(54) Revenue participation interests with guaranteed returns and methods related thereto

(75) Inventor: Stephen Watkins, Lighthouse Point, FL (US)

Correspondence Address: NELSON MULLINS RILEY & SCARBOROUGH, LLP, 1320 MAIN STREET, 17TH FLOOR, COLUMBIA, SC, 29201, US

(73) Assignee: ENTREX INC., Chicago, IL (US)

(21) Appl. No.: 12/228,185

(22) Filed: Aug. 11, 2008

Related U.S. Application Data
(60) Provisional application No. 60/955,100, filed on Aug. 10, 2007.

(51) Int. Cl. G06Q 40/00

(52) U.S. Cl. 705/37; 705/35

(57) ABSTRACT

A financial product and method for creating a financial product is provided wherein an investor receives a return based on the future sales or revenues of an issuer and a portion of the investor's investment is guaranteed as a return at maturity of the financial product.

### CROSS-REFERENCES TO RELATED PATENTS AND PATENT APPLICATIONS

This application is a non-provisional of and claims priority to U.S. Provisional Patent Application 60/955,100, filed Aug. 10, 2007.

### BACKGROUND OF THE INVENTION

(1) Field of the Invention

The present invention relates generally to financial products concerning and methods for implementing a revenue participation interest to provide investors with payments based on an issuer's revenue stream wherein the investors' investments are guaranteed with certain types of securities.

(2) Description of the Related Art

Revenue participation interests have historically taken the form of franchise agreements (e.g., establishment of restaurants), royalty payments in exchange for a license to intellectual property (e.g., a patent license), and, recently the issuance of a finite-term security by an issuer to investors in exchange for consideration such as cash. The latter example has been deemed a “Sales Participation Certificate” by its inventor, Henry Schulman and is described in detail in U.S. Pat. No. 7,149,719 and in U.S. patent application Ser. Nos. 10/153,052 (published as US 2003/0204459) and 11/057,552 (published as US 2005/0222940), all three of which are incorporated herein in their entireties by reference thereto and which are collectively referred to as Schulman herein. Such Sales Participation Certificates and their methods are generally referred to herein as “Revenue Participation Interests.”

To date, the various permutations of revenue participation interests embodied in Sales Participation Certificates have been of relatively short (12 years or shorter) finite life terms or are established with a claim against a finite pool of assets. These structures, as conceived, are meant to be secured or unsecured debt instruments such that a component of the cash payments to investors will likely be treated as repayment of principal while the remainder, which constitutes the investor's return component, would likely be treated as interest income, which may allow the issuing company to take a deduction for payments made to thereby reduce its tax liability.

The financial products created by Schulman provide a return that is a function of future sales/revenues, preferably gross sales/revenues, over a specified period of time. As opposed to asset-backed securities, securitization of such a function represents a property interest in the stream of payments from an organization's sales or other revenues. Typically, but not always, no assets segregated as collateral for this security. The terms to the issuer include providing capital to the issuer in exchange for a return to the investor that is a function of future sales of the issuer over a specified period of time.

Recently, revenue participation interests have been created that provide investors with payments based on an issuer's revenue or sales stream where the term of the product is perpetual, i.e., not limited by a specified time period. This type of product is referred to herein as a “Perpetual Revenue Participation Interest.” This type of financial product is described in a co-pending and co-owned patent application entitled Perpetual Revenue Participation Interests and Methods Related Thereto having inventor David Weild IV, and filed with the United States Patent and Trademark Office on Jul. 22, 2008. That application is incorporated herein in its entirety by reference thereto.

Whether a perpetual or a term revenue participation interest, such financial products are generally not “guaranteed” in that the investment of the investor is not “guaranteed” to be returned to the investor at maturity. In fact, in the perpetual revenue participation certificate, there is no “maturity” date or “termination” date because the return exists theoretically in perpetuity. In the term revenue participation interest, the company participating in the revenue generation (or the entire group of companies participating in the revenue generation if the product is administered as a collective “fund” from several companies) may cease to exist. In such case, the investor may never have recouped his investment before the company has gone out of business. For example, the investor may have invested $500 initially and, over the course of the life of the company (or fund) may have only received $200 as a percentage of the revenue generated during the company's life. In this instance, the investor has lost $300 on this investment.

Other means and methods of investing have been available. Treasury bills, savings bonds, stocks, bonds, etc. are well-known investment vehicles in the industry.

As is known, a bond is a debt security, in which the authorized issuer owes the holders a debt and is obliged to repay the principal and interest (the coupon) at a maturity date. In its simplest form, a bond is a loan in the form of a security where the “issuer” is equivalent to the “borrower,” the “bond holder” is equivalent to the “lender,” and the “coupon” is equivalent to the “interest” paid on a loan. Bonds enable the issuer to finance long-term investments with external funds.

Bonds and stocks are both securities, but the major difference between the two is that stockholders are the owners of the company (i.e., they have an equity stake in the company), whereas bondholders are only lenders to the issuing company.

Treasury securities are government bonds issued by the United States Department of the Treasury. They are the debt financing instruments of the U.S. government, and are often referred to simply as “treasuries.” There are four types of marketable treasury securities: Treasury bills, Treasury notes, Treasury bonds, and Treasury Inflation Protected Securities (TIPS). There are several types of non-marketable treasury securities including State and Local Government Series (SLGS), Government Account Series debt issued to government-managed trust funds, and savings bonds. All of the marketable Treasury securities are liquid and are heavily traded on the secondary market. The non-marketable securities (such as savings bonds) are issued to subscribers and cannot be transferred through market sales.

Treasury bonds (known as “T-Bonds”) mature at a certain date determined at issuance, typically between 5 and 30 years. T-Bonds usually have a coupon payment every six months or every year.

### SUMMARY OF THE INVENTION

Briefly, the present invention is a financial product, and method of implementation, that offers investors an opportunity to invest in companies and receive return based on the companies' revenue stream, while guaranteeing a certain value for the investment. Specifically, a net asset value of the investment is guaranteed through the company's (or fund's) purchasing of guaranteed investment vehicles, such as U.S. treasuries. The investor receives a coupon representing a percentage of net asset value of return to the investor at some designated time period (such as every year) until maturity. This return is generally a percentage return based on the revenue generated and is the revenue participation interest described above. However, at maturity of the investment, the investor receives 100% (or some agreed-upon lower percentage) of the net asset value of the investment as a guaranteed return. The guaranteed return is realized by investing in guaranteed securities, such as U.S. Treasury Bonds or Notes.

### DESCRIPTION OF THE FIGURE

FIG. 1 is a spreadsheet showing the calculation exemplified in the Example set forth below.

### DETAILED DESCRIPTION OF THE PREFERRED EMBODIMENTS

Reference now will be made in detail to the embodiments of the invention, one or more examples of which are set forth below. Each example is provided by way of explanation of the invention, not a limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment.

Thus, it is intended that the present invention covers such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

The present financial products provide investors with payments of cash or other returns based on an issuer's revenue or sales stream. In addition, the investors are “guaranteed” that a certain percentage (in most cases 100%) of their original investment will be returned at the maturity of the financial product. The guarantee is made possible through the issuer (either the company or a group of companies utilizing a fund) purchasing a security that is guaranteed by an entity such as the U.S. Federal government. For example, one particular way of carrying out this method is for the issuer to purchase, with a portion of the initial investment, a U.S. Treasury Bond who maturity face value is equal to the amount of the net asset value provided by the investor.

An example of this type of investment is as follows: A broker (or fund manager) determines according to the following scenario that for every $125 a company needs, a $500 instrument will need to be sold. An investor is willing to invest $500 for one revenue participation certificate with a guaranteed return portion. Of the $500 invested, a certain amount may be retained as commission for the broker. In this example, the commission is $25, leaving a net asset value invested of $475. Of the $475, the broker then purchases a “guaranteed” security that, upon maturity will be worth the full amount of the $475. For example, $350 is used to purchase a 5-year treasury bond, leaving $125 for the company to have and use as capital. Every year (or some other period as determined by the issuer), the instrument pays the investor a certain percentage of the revenue generated by the company or the companies. For example, this payment may be 1% of annual revenue. This amount is paid directly to the investor, similarly to a “coupon” attached to a bond. At maturity of the bond (i.e., 5 years in this scenario), the investor is then paid $475, which represents the original net asset value invested and the instrument is terminated.

One embodiment of a method according to the invention includes providing forms to an issuer and to an underwriter and terms to an issuer and to investors. The terms to the issuer include providing capital to the issuer in exchange for a return that is a function of future gross sales/revenues for some specified period of time. The method further includes determining from the issuer, e.g., from the forms, the amount of capital desired and calculating an appropriate function, e.g., percentage, of sales to achieve the desired capital contribution to the issuer.

Based on an appropriate function, e.g., percentage, of sales, the method creates instruments in sufficient numbers and appropriate denominations to facilitate trading in the underlying financial product. One embodiment of a method according to the invention, given a proposed issue amount, divides the issue amount by a fixed denomination to determine the number of instruments. The fixed denomination is such that the instruments are tradable securities given the then current market conditions. In other words, one can set the value of the fixed denomination to reflect the denominations of other existing securities, e.g., other similar securities, in the market. For example, if the issue amount is 1 million dollars and the fixed denomination is 100 dollars then the number of instruments is 10,000. Approximately concurrent with, and in one embodiment prior to, the creation of instruments, the method may include obtaining opinion of counsel, based on the terms (which may be standard terms and which may or may not be negotiated/negotiable) and completed forms, hiring a registrar to keep the books, and hiring a trustee to collect and distribute revenues owed. Finally, the method includes conducting a public or private offering of the security instruments created.

Thus, one embodiment of a method according to the invention securitizes a portion of the proceeds of future gross sales/revenues, an item that is easily audited, turning it into property that can be traded in a secondary market on an exchange, should an exchange arrange to trade in these securities, or over-the-counter (OTC). An OTC security is a security that is not traded on an exchange, usually due to an inability to meet listing requirements. For such securities, broker/dealers negotiate directly with one another and/or investor(s) over computer networks and by phone.

One embodiment of a method according to the invention includes creating a financial product by providing forms and terms between the issuer and the trustee who is the fiduciary representing the interests of the investor, and between the issuer and the underwriter who is to be paid for underwriting the issue. Typically, issuers sell and investors buy and trade in securities with the help of market intermediaries. In the primary market, underwriters distribute securities from issuers to investors. In other words, an issuer provides the issuer's obligation to the underwriter in exchange for a commitment of capital. The underwriter in turn provides the issuer's obligation to investors in exchange for money. As noted above, the terms of the issuer's obligations, when issuing this security, include providing a return that is a function of future sales/revenues. The trustee then collects and distributes revenues owed pursuant to the issuer's obligations outlined in the forms and terms. In the secondary market, a broker/dealer trades securities for money with investors. Thus, a generic investor can sell sales certificate(s) to a broker/dealer for money and another generic investor can purchase sales certificate(s) from the broker/dealer for money. The broker/dealer typically prefers to end each trading day with no inventory, i.e., with longs equal to shorts. In addition, if available, the broker dealer can trade as agent for investors on an exchange.

The entire process, or portions of the process, can be handled by computer systems. For example, the creation of the instruments representing the security, the transacting for the returns to the investors, the tracking and calculation of payouts based on issuer's sales, and the receipt and distribution of capital from the investors can all be handled jointly or separately by a computer system.

The “Revenue Participation Interests” of the present invention may have the following features:

1) The Revenue Participation Interest would represent a limited term interest in a company's revenues (including, but not limited to, the full range of corporate structures such as C-Corp, S-Corp, REIT, RIC, LLC, LP, etc.)

2) Pricing of the Revenue Participation Interest may or may not be negotiated.

3) Revenue Participation Interests may or may not have dividends declared.

4) Revenue Participation Interests may or may not have an “ex-distribution” date that determines whether the purchaser of the instrument is entitled to the most recent declared distribution.

5) Revenue Participation Interests may or may not include a distribution true-up (also known as a “make whole”) provision wherein if a subsequent discovery of a discrepancy (whether by audit or some other mechanism) in GAAP revenues determines that the beneficial owners were entitled to larger distribution, the holders of record on the original distribution date would be made whole and this incremental payment may or may not include interest and/or penalties.

6) Revenue Participation Interests may or may not be traded.

7) Revenue Participation Interests from a particular issue or issuer may be held by one or more investors.

8) Revenue Participation Interests may be issued in the private market or as publicly registered instruments.

9) Revenue Participation Interests may or may not be offered by standard term sheets.

10) Revenue Participation Interests may or may not have been negotiated (subject to negotiated terms)

11) Revenue Participation Interests may or may not be denominated in increments and prices that facilitate trading.

12) Revenue Participation Interests may or may not include an issuer-held redemption feature.

13) Revenue Participation Interests may or may not have “hard call protection” for a defined period of time, meaning that the revenue participation interest cannot be redeemed or exchanged for some period of time (e.g., 3 years from the date of issuance).

14) Revenue Participation Interests may or may not have “soft call protection” meaning that the Revenue Participation Interest must be trading at some premium to issue price (e.g., 30 days) for a minimum number of days before it can be called or exchanged.

15) Revenue Participation Interests may or may not include an investor-held mandatory or optional redemption (“put”) features that may or may not be activated by an event such as the sale of the company.

16) Revenue Participation Interests may or may not have a mandatory redemption or exchange feature such as, in the event that the issuer defaults on any indebtedness, the Revenue Participation Interests are automatically exchanged for the debt or other securities of the issuer.

17) Revenue Participation Interests may or may not include an issuer-held exchange option feature:

a. Where the Revenue Participation Interest is exchangeable for a third security (such as common stock) at the option of the issuer or in the event of an event trigger, such as an IPO on some pre-specified or formula that defines the rate at which the exchange would take place.

b. Where a similar value of one of the issuers securities may be exchanged for all shares of a Revenue Participation Interest, then outstanding. So, for example, if the common stock of the company was traded and the Revenue Participation Interests were also traded, the latter may be exchanged for common stock, for example, based on the value a value set for the Revenue Participation Interests that is the higher of the then current price, when announced or the average of the last 30 calendar days of trading prices on the close of market. The value of the common stock used for this exchange might be at the lower of the then-current price of the common stock or the average of the last 30 calendar days of trading prices on the close.

c. Alternatively, the issuer could tender cash or securities for the Revenue Participation Interests then outstanding.

18) Revenue Participation Interests may or may not include an investor held conversion feature (e.g. where the Revenue Participation Interest is convertible into a fixed, or variable by some formula, number of shares of common stock or some other security of the company).

19) Revenue Participation Interests may or may not have an embedded (or strippable) investor-held “put” option that requires the issuer to repurchase the instrument on a certain date(s) at a specified price(s) (including a price specified by formula).

20) Revenue Participation Interests may or may not be current cash pay, accrued but not cash pay, or partial cash pay instruments.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

### EXAMPLE

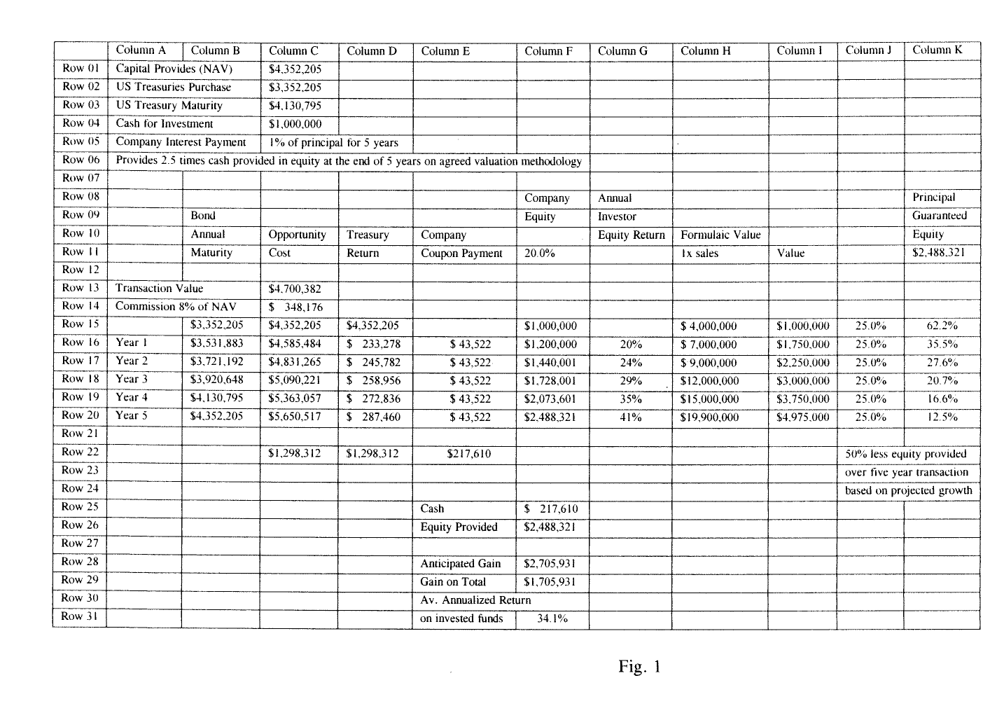

The following example is meant to be exemplary only of an investment method according to the present application and the invention is not limited solely thereto. By way of example, only (wherein the parentheticals represent the column and line numbers on FIG. 1):

Mechanics:

Fund invests in $470 instrument for every $100 that an Issuer company needs in capital.

$470—Transaction value (C13)

$35-8% commission paid to selling broker (if applicable) (C14)

$435-100% of the Net Asset Value (minus commission) (C15)

$335—Fund buys guarantee of Net Asset Value at 5-year maturity (B15)

$100—Capital to company (F15)

Company Pays:

$4.35—quarterly payment, assuming a 1% annual revenue participation to the owner of the security (E16-20)

Investor Receives Guaranteed Principle Return at Maturity (Year 5):

$435-100% of Net Asset Value (maturity of U.S. Treasury) (B20)

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the preferred versions contained therein.

What is claimed is:

1. A method for creating a financial product having a maturity date comprising: providing terms to an issuer and to investors, the terms to the issuer including providing capital to the issuer in exchange for a return that is a function of future sales or revenues, the terms to the investors being the receipt of a return based on the issuer's future sales or revenues, the capital provided to the issuer being provided by investors investing in the financial product, and a portion of the investors' investment being guaranteed such that the investors receive such portion as a return at the maturity of such financial product; and arranging for the creation of instruments representing investment in the financial product.

2. A financial product created by the method of claim 1.

3. A computer-implemented method for creating a financial product having a maturity date comprising conducting one or more of the following steps with a computer system:
a. providing terms to an issuer and to investors, the terms to the issuer including providing capital to the issuer in exchange for a return that is a function of future sales or revenues in perpetuity, the terms to the investors being the receipt of a return in perpetuity based on the issuer's future sales or revenues, the capital provided to the issuer being provided by investors investing in the financial product, and a portion of the investors' investment being guaranteed such that the investors receive such portion as a return at the maturity of such financial product; and
b. creating instruments representing investment in the financial product.
